(19) United States
(12) Patent Application Publication
(10) Pub. No.: US 2004/0015869 A1
(43) Pub. Date: Jan. 22, 2004

(54) Method and system for performing an investigation

(76) Inventors: James W. Herriot, Palo Alto, CA (US); Bruce K. Sawhill, Santa Fe, NM (US); Carl W. Hunt, Springfield, VA (US)

Correspondence Address: PENNIE & EDMONDS LLP, 1667 K STREET NW, SUITE 1000, WASHINGTON, DC, 20006

(21) Appl. No.: 09/876,254

(22) Filed: Jun. 8, 2001

Related U.S. Application Data
(60) Provisional application No. 60/209,981, filed on Jun. 8, 2000.
(60) Provisional application No. 60/209,978, filed on Jun. 8, 2000.
(60) Provisional application No. 60/258,869, filed on Jan. 2, 2001.

(51) Int. Cl. G06F 9/44

(52) U.S. Cl. 717/126; 717/155

(57) ABSTRACT

The present invention relates generally to a method and system for performing an investigation to determine one or more hypotheses in different contexts including criminal trials, scientific inquiry and military intelligence. More specifically, the system comprises one or more tuples to represent the knowledge of one or more objects involved in the investigation wherein the tuples are exchanged among the objects to perform the investigation.

### RELATED APPLICATIONS

The present invention claims priority to U.S. provisional application No. 60/209,981, filed on Jun. 8, 2000, titled, “A Method and System for Allocating Investigative Resources”, the contents of which are herein incorporated by reference. The present invention also claims priority to U.S. provisional application No., 60/209,978, filed on Jun. 8, 2000, titled, “A Method and System for Evidence Marshaling”, the contents of which are herein incorporated by reference. The present invention also claims priority to U.S. provisional application No., 60/258,869, filed on Jan. 2, 2001, titled, “A Method and System for Performing an Investigation”, the contents of which are herein incorporated by reference.

### FIELD OF THE INVENTION

The present invention relates generally to a method and system for performing an investigation to determine one or more hypotheses in different contexts including criminal trials, scientific inquiry and military intelligence. More specifically, the system comprises one or more tuples to represent the knowledge of one or more objects involved in the investigation wherein the tuples are exchanged among the objects to perform the investigation.

### BACKGROUND

Earlier attempts to perform investigations include classical artificial intelligence, Bayesian inference nets and theorem proving. Classical artificial intelligence methods use top-down reasoning and include expert systems. But they do not involve humans in the method. Further, they are too oriented towards human reasoning and are not sufficiently inferential. Moreover, they can only see things that have been seen before. While new versions of automated theorem proving using Prolog (i.e. Eclipse, Mozart, CliP) are more suited to parallel computation, they still rely on a centralized problem description. Like artificial intelligence methods, they are not oriented to having a human in the loop. Further, they are not equipped to deal with inconsistency and disambiguation and do not form an ecology of computation. While Bayesian inference nets are a powerful tool for calculating inference structures, they have difficulty in assigning probabilities to implied linkages. These and other earlier attempts to perform investigations are inefficient for current investigational techniques and are not able to leverage distributed knowledge of multiple investigations in an effective fashion. Further, classical notions of computation for a well defined problem and a deterministic solution are inappropriate for these investigations.

Accordingly, there exists a need for a system and method for performing investigations that represents knowledge distributed among multiple investigators and exchanges this knowledge among the investigators to generate one or more hypotheses. This need is important because of the increasing complexity and anonymity of criminal and military acts.

### SUMMARY OF THE INVENTION

It is an aspect of the present invention to present a system for performing an investigation to determine one or more hypotheses comprising:

one or more nodes representing one or more objects wherein said one or more nodes comprise one or more tuples representing questions and answers and wherein said nodes exchange said one or more tuples to perform the investigation.

It is a further aspect of the present invention to present a system for performing an investigation to determine one or more hypotheses that further comprises one or more edges connecting at least two of said nodes to form at least one graph for representing relations among the objects.

It is a further aspect of the present invention to present a system for performing an investigation to determine one or more hypothesis that further comprises one or more utilities to detect a phase transition in the graph representing a movement from a brittle scenario of the hypotheses supported by few precarious paths in the graph to a robust scenario of the hypotheses supported by multiple paths in the graph.

It is a further aspect of the present invention to present a system for performing an investigation to determine one or more hypothesis wherein incompleted ones of said tuples represent questions and completed ones of said tuples represent answers.

It is a further aspect of the present invention to present a system for performing an investigation to determine one or more hypothesis wherein the one or more nodes also exchange the one or more tuples with at least one human expert.

It is a further aspect of the present invention to present computer executable software code stored on a computer readable medium, the code for performing an investigation to determine one or more hypotheses, the code comprising:

code to represent one or more objects with one or more nodes;

code to store questions and answers in one or more tuples at said one or more nodes; and

code to exchange said tuples among the one or more nodes to perform the investigation.

It is a further aspect of the present invention to present a programmed computer system for performing an investigation to determine one or more hypotheses comprising at least one memory having at least one region storing computer executable program code and at least one processor for executing the program code stored in said memory, wherein the program code includes

code to represent one or more objects with one or more nodes;

code to store questions and answers in one or more tuples at said one or more nodes; and

code to exchange said tuples among the one or more nodes to perform the investigation.

### BRIEF DESCRIPTION OF THE DRAWINGS

FIG. 1 displays exemplary suspect observations that can be used by the present invention to solve a crime.

FIG. 2 shows a flow diagram of a method for determining which variable in an expression to resolve to improve the expression's satisfiability 200.

FIG. 3 displays an overview of the Agent Based Evidence Marshalling Model (ABEM) 300 of the present invention.

FIG. 4 displays the components, functions and data representations of the present invention.

FIG. 5 displays a detailed architecture of ABEM.

FIG. 6 shows how the agents in the ABEM interact.

FIGS. 7A-7E, 8A-8E and 9A-9E show panels from an execution of the ABEM.

FIG. 7A shows the panels from FIGS. 7B-7E on one sheet. FIG. 7B illustrates initial conditions. FIG. 7C illustrates the state of ABEM after the Computer has learned from the Box that the Box can be its substitute. FIG. 7C also shows the Box's response and the Computer's incorporation of that knowledge in its table. FIG. 7D illustrates the state of ABEM after the Computer has learned information about is location from Jones.

FIG. 8A shows the panels from FIGS. 8B-8E on one sheet. FIG. 8B displays examples of query-learning interactions in ABEM. FIG. 8C shows examples of the SUV learning from multiple sources. FIG. 8D shows the state of ABEM after the UPS has learned the Truck's location from Smiggs. FIG. 8E illustrates the state of ABEM as the Box learns of a critical substitutionary relationship: “sub box suv” from the SUV.

FIG. 9A shows the panels from FIGS. 9B-9E on one sheet. FIG. 9B shows the Computer, working of a substitution-based inference, looking for a substitute for the Box. FIG. 9C shows the update of the Computer's knowledge table depicting that it has inferred the importance of the Box. FIG. 9D illustrates the Computer's knowledge table from a different run of the ABEM model. FIG. 9E shows an additional Computer Knowledge Table from an additional run.

FIG. 10 shows a composite view of selected instantiations in ABEM.

FIG. 11 shows a later view of selected learning in ABEM.

FIG. 12 discloses a representative computer system in conjunction with which the embodiments of the present invention may be implemented.

### DETAILED DESCRIPTION OF THE PREFERRED EMBODIMENT

The present invention allows an organization carrying out an inquiry, to scientifically engineer the optimal investment of its investigative resources. For example, in a criminal inquiry we want to know “Did Joe do it?” and, if so, how. Perhaps we begin with a set of fragmentary conjectures like “Joe owned a knife.” On the one hand, we would like to automatically construct complete scenarios from the atomic conjectures. And on the other hand we would like automated direction as to which facts to investigate and in what order. The present invention addresses both of these needs.

The present invention includes technology graphs which define an environment consisting of computational objects with interlinking functionalities. The computational objects can communicate with each other and can learn and adapt their behavior. A relational language including has-a, is-a and does-a exists between the computational objects. Under an exogenous request, the computational objects attempt to organize themselves into a functional whole. Technology graphs were described in U.S. patent Ser. No. 09/345,441 filed on Jul. 1, 1999, titled “An Adaptive and Reliable System and Method for Operations management”, the contents of which are herein incorporated by reference.

The present invention also makes use of agent-based evidence marshalling (“ABEM”). In ABEM, factoids or trifles attempt to assemble themselves into a hypothesis. ABEM can be distinguished from a generic technology graph because with ABEM, not all ingredients to create a viable hypothesis are there to begin with. Instead the ABEM approach requires human intervention to guide the reasoning. The present invention streamlines human investigation by filtering out unreasonable hypothesis fragments.

Without limitation, many of the following embodiments of the invention are described in the illustrative context of an investigation of a theft of an object, such as a computer. However, the aspects of the embodiments of the invention are also applicable in any context involving an investigation to determine one or more hypotheses. These aspects include the representation of knowledge with one or more tuples distributed among nodes representing objects and the exchange of these tuples among the nodes to generate one or more hypotheses. Exemplary contexts include medical diagnosis, criminal investigations, military intelligence, scientific research, de-Babelization of the information age, search engines, detection of complex market behaviors, network intrusion and distributed processing in robots for space travel and hostile environments. Indeed, any situation characterized by a plethora of facts supporting hypotheses coherently organized into plausible scenarios, and a question as to which facts to uncover first (i.e. in what order to do fact-finding) may benefit substantially from this invention.

One such illustrative context involves a simple story of a theft of a computer that is used in a fraud against the U.S. Government. Typically, there are several linking details that are missing which an investigator could use to piece together and intellectually correlate to derive hypotheses (e.g. could two different boxes be used for one purpose). The ABEM approach of the present invention leverages the investigator's experience and intuition interactively.

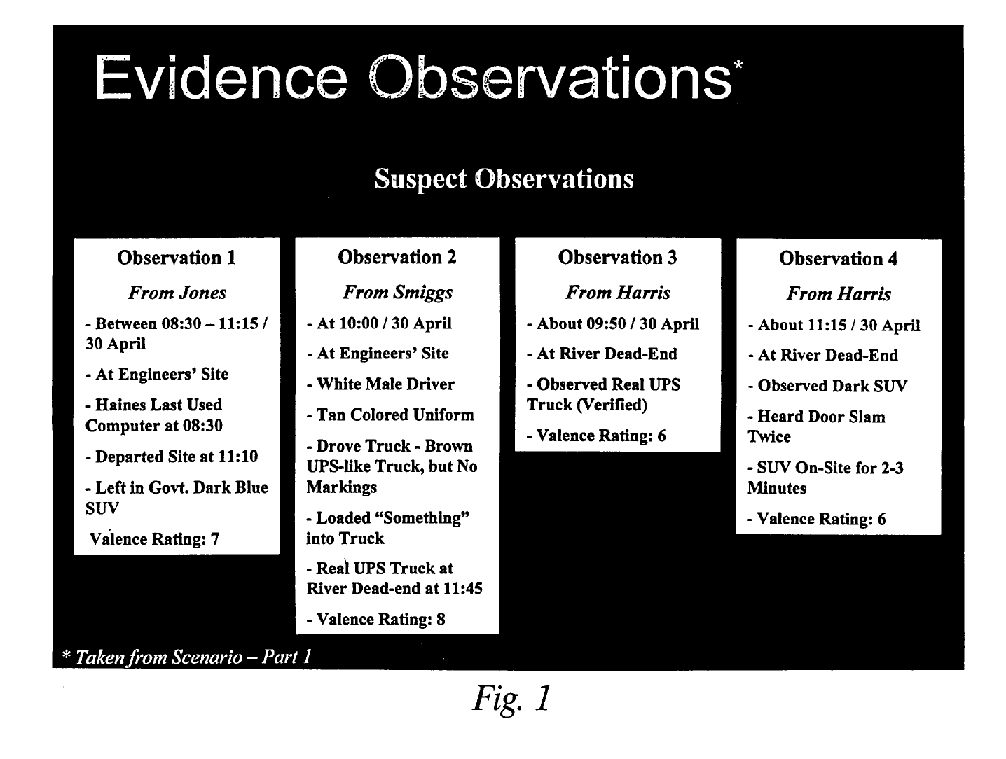

FIG. 1 displays exemplary suspect observations that can be used by the present invention to solve a crime. The present invention includes many different processes. For example, the identity process links together similar elements from many factoids as disparate observations of the same object as part of the construction of a space-time trajectory for an object in the investigation. For example, the identity process could tie together three observations of the same vehicle.

Another process called the nomination process ties in new information with existing information using the notion of adjacent possible that is explained in U.S. patent application Ser. No. 09/345,441, titled, “An Adaptive and Reliable System and Method for Operations Management”, filed Jul. 1, 1999, the contents of which are herein incorporated by reference. For example, tire tracks imply the presence of a vehicle and thus, nominate a vehicle to be present. Another process called the substitution process determines multiple means that accomplish the same goal. It is used because criminal activity often depends on deception and deception employs substitution. For example, a stolen computer could be transported in a white box, a brown box, or a vehicle carrying either box.

One goal of the present invention is to construct a crime scenario. Every observed element (computer, vehicles, people) becomes an object. In the preferred embodiment, the present invention is implemented in Java and the objects are Java objects. The objects of the present invention justify their existence and attempt to construct their space-time trajectories in the domain of investigation. For example, a stolen computer attempts to figure out its own trajectory.

If there is insufficient data to construct a space-time trajectory, a question is directed to a human investigator. Typically, many calls will be made for human help early in the process. As the question and answer cycle proceeds, the present invention remembers the previous results. Questions then become fewer and more astute as a body of knowledge is accumulated. An exemplary format for a stylized discrete version of space time includes “by the river, in the trailer, between 8:30 and 11:00am”. The present invention includes the notion of visibility where we can see into some space-time regions and not others.

The present invention uses a distributed data topology. This topology aligns with a mental map of the problem. It is also a natural way to organize a human-computer interface and facilitates parallel processing. Its advantages includes a distributed state and robustness.

The present invention uses tuples as a means to encode technology graph linkages. For example, relations like “has-a”, “needs-a”, “does-a” and “is-a” can be encoded as incomplete vectors. Like UNIX, where 1*.ps lists all files that have the form .ps. the * notation of the present invention allows incomplete vectors. For example, if a computer “needs-a” transporting function that was at site Sₐ at time Tₐ, the corresponding tuple is of the form {Sₐ, Tₐ, *}.

In order to implement a widely distributed investigation, the present invention uses peer-to-peer functionality or Internet topology and protocols such as Napster. The present invention uses a parallel version of a database query language like SQL.

The present invention formalizes the question and answer (Q&A) traffic among nodes so that the information collected in the technology graph (TG) nodes can be further used to inform the node's continuing ongoing line of questioning. A node can ask “questions”, gain new information (for itself) in the form of “answers”, which can, in turn, be used to generate new more sophisticated questions. In addition, the entire TG can be subjected to dynamical phase transition analysis to detect and “engineer” the graph toward representation of more plausible “believed in” robust scenarios.

The preferred approach of the present invention to Evidence Marshalling (EM) is to distribute the processing of searching for plausible scenarios onto separate TG nodes, each corresponding to a particular aspect of an ongoing investigation—whether it be medical diagnostic, scientific discovery, criminal detective work, military intelligence, etc. The TG nodes correspond as much as possible to how we think about the problem, ie to our “mental furniture.”

In TGs, the various nodes are implemented using computational “agents”. Each node makes requests to other nodes, such as “needsa piston”. If another node can satisfy the request it may respond something like “isa piston”. Hence the relationship among the nodes are “typed” (come in many specific varieties) much like object oriented computer languages like C++ or Java. Much of the power of object oriented computer languages is in their dynamic typing capabilities. Rather than being limited to a few predefined types such as “int” or “char”, new types can be designed by the programmer such as “rectangle”, “vector”, or “employee”. Likewise TGs have what you might call “designer relationships”, making possible a rich set of possible relationships among the nodes. This is important in EM because of the immense subtlety of relationships in human-based investigations. For example, a computer can “be contained” in a box. An unmarked truck can “masquerade” as a UPS truck. A tire print can “imply” the presence of a truck at a previous time.

Technology Graphs have immense power drawing from the flexibility of having a wide range of “needsa”, “doesa”, “isa”, etc. capabilities and corresponding inter-node relationships. In this invention we have formalized the syntax of the “needsa”, etc., requests using tuples.

In the EM domain, we apply TGs to the construction of arguments and scenarios built up from the exchange of information or evidence. Hence the “needsa”, etc., requests become questions and the responses become answers. Furthermore, we want fecund answers to lead to novel new questions, potentially leading to a explosion of novel questions, possibly a “phase change” phenomenon, a la complex systems.

In criminal investigation, for example, the various TG nodes might represent people (witnesses), objects (stolen computer, boxes, trucks, etc.), and even locations (building, parking lot, river bank, etc.). In this EM application of TGs, we endow each node with the drive or desire to track its trajectory in space-time. Each node may ask other nodes questions in an ego-centric quest for information about itself. This is the Q&A traffic which is the “commerce” of this kind of TG.

One aspect of the present invention in applying TGs to EMs was encoding questions and answers formally as tuples. Using this approach, questions become “incomplete tuples” and answers become “completed tuples”. For example the difficult-to-parse (by computer) request “needsa location for the computer at 10am” becomes the tuple, (loc, computer, 10am, ?) where the “?” represents an to-be-completed element of this 4-tuple. For a node to answer the question, it would search its own internal data base (ie set of stored tuples) and look for tuples which exactly match the 3 known elements. Perhaps a node finds a tuple in its internal data base, (loc, computer, 10am, house). This complete tuple becomes the “answer” to the original “question”. And the node with the answer sends this completed tuple back to the questioning node, which then adds it to its internal data base.

There are other tuple types than “location”. Some information is about possible substitution of one thing for another. For example, because a computer can fit inside of box, a box can sometimes “substitute” for a computer. In fact, the notion of substitution is closely related to deception, which is one of the principle techniques of criminals. In science too, much of the initial confusion in an investigation was often, in retrospect, one thing masquerading as something else. Substitution is a potent issue in all applications of EM.

The present invention easily uses tuples to represent substitutions as well. For example information about computers fitting inside of boxes can be encoded as the tuple (substitute, computer, box), or perhaps more precisely as the tuple (fitsInsideOf, computer, box). For example, perhaps the “computer” node begins with no knowledge. It might begin asking if anyone knows its whereabouts (loc, computer, ?, ?) and any time or place. This may yield some information, but may also hit a dead end if a criminal concealed it inside a box. However the computer may ask the box if it knows if it (the computer) can fit inside of the box. Perhaps the box says “yes”, in effect. Formally this would look like: computer sends (substitute, computer, ?) and the box searched it data base and answers (substitute, computer, box). Now the computer has new information and can open a whole new line of questioning, now dynamically generating the new novel question (loc, box, ?, ?) or “has anyone seen a box around here?”. Of course, boxes can be carried by trucks, so the lines of questioning can open up exponentially.

An additional feature of the present invention is the integration of humans into the loop. If a node doesn't know the answer to a incoming question, it may elect to ask a human expert to fill in a void in its knowledge. For example, the “box” may not initially know if a computer can fit inside of it. The box may ask a human, get an answer, and end up more informed, and more useful to other nodes. Dynamically integrating humans in the process is powerful and important. This way the humans who initially create the TG in the beginning do not have to anticipate all the data which will be needed as the Q&A process unfolds. Furthermore, since the processing in the TGs is distributed according to “how we think about it”, the real-time human resources can be mapped to the nodes. The box node will “call up” a human who is an expert on boxes. And of course, the node representing witnesses will want to call upon the actual humans they represent to glean more information from then as the investigation proceeds.

This TG approach of the present invention also has the ability to dynamically create and destroy nodes in the system. For example a tire print may choose to “nominate” a new node representing a possible vehicle in the area. Or two nodes may choose to merge if they discover that they are the same, or identical. These processes of “nomination” and “identity” can dynamically change the population of nodes.

So, we can see that in the TG the process of Q&A exchange will tend to create inter-node links and rich structure. In addition, the processes of “nomination” and “identity” also dynamically alter the structure of the TG graph over time. Complex graphs tend to be ripe with phase transitions. In the EM domain, these phase transitions correspond to brittle scenarios moving to robust scenarios. Intuitively there are scenarios which may be true but supported by a thin precarious chain of evidence. And there are other scenarios which are plausible and “believed in” because they are supported by a rich set of redundant pathways to the conclusion. The present invention includes the complexity techniques used to figure out where the highest grade “ore” is to direct Q&A attempts to push the whole TG toward a phase transition which would lead to this robust “believed in” EM regime.

The present invention enables the automatic and human assisted assembly or marshalling of evidence into plausible scenarios using powerful techniques drawn from Technology Graphs, further enhanced by dynamically typed tuples, and subjected to dynamical phase transition detection and engineering in search of plausible scenarios.

Another aspect of the present invention uses Technology Graphs and a algorithm to determine one or more facts to resolve in order to direct an investigation. This aspect of the present invention uses Technology Graphs to self-organize hypotheses into entire stories or scenarios. As previously explained, Technology Graphs provide a way to formalize and model the relationships among self-constructing parts of a system—whether the parts are pistons in an automobile engine or hypotheses in a scenario. This aspect of the present invention provides an automated way for hypotheses to self-construct themselves into full-blown scenarios with minimal human intervention.

This aspect of the present invention also addresses the vexing problem of believability of a scenario, or “robust truth”. If an entire scenario hangs on a single fact, then while we may claim the scenario to be technically true, we may not believe deeply in its truth. After all, if that lone fact is cast in doubt by the defense (possible receipt forgery, unreliable witness, etc.), then the whole scenario can fall. If instead, there is no single weakest link fact, then we call this robust truth. In this case, there are multiple pathways to the truth of the scenario. Even if one fact goes sour and kills a “truth pathway”, there are still other truth pathways to support the overall truth of the scenario. This approach provides a way to formalize the notion of plausibility or believability.

This aspect of the invention includes three basic types of entities:

Hypotheses include the elemental units of conjecture, e.g. “John owns a knife.” For hypotheses to be true, they must be supported “vertically” by supporting facts—perhaps a Boolean expression of facts. For hypotheses to be interesting and important, they must be part of an overarching “horizontal” scenario(s).

Scenarios include the stories that ultimately matter, e.g. “John killed Colonel Mustard.” Scenarios are a fabric, woven from a patchwork of hypotheses. Scenarios are (self-) constructed “horizontally” from a set of related hypotheses. Accordingly, scenarios are also supported by the facts which support the component hypotheses—typically a large Boolean expression of facts—each fact represented by a Boolean variable. A scenario includes multiple scenarios that are being considered simultaneously, since these can be logically “or-ed” together into a single larger scenario.

Facts are the basic units of truth. They are true (or false) all by themselves. Facts support hypotheses and ultimately entire scenarios. However, the word, fact, in this invention is used in a broader fashion because it includes an unresolved or potential fact. We do not know if an unresolved fact is true or false. Facts are unresolved until they are investigated. Once successfully investigated, facts become either true or false. Therefore, values for facts include the following: unresolved, true, or false. One of the goals of this aspect of the present invention is to help investigators determine which (as yet) unresolved facts to investigate and attempt to resolve. In one embodiment, resolved facts can be idealized as Boolean variables. In an alternate embodiment, resolved facts can be specified as continuous variables in the interval 0 to 1 to represent its level of certainty. Without limitation, many of the following embodiments of this aspect of the present invention represent facts with Boolean variables. However, the principles of this aspect of the present invention are also applicable to other representations of facts which include the notion of uncertainty. These principles include the definition of a profile to represent an expression of variables and the identification of at least one of the variables to set in order to improve the satisfiability of the profile.

This aspect of the present invention includes the self-assembly of scenarios from hypotheses. Hypotheses are encoded using the formalism of the Technology Graphs. Potential linkages coupling hypotheses together are specified as relationships such as “needs-a”, “does-a”, “is-a”, “has-a”, etc. For example, the hypothesis, “John owns a knife” may have a needs-a attribute of the form “needs-a source-of-knife”. Perhaps there is another hypothesis, “John bought a knife” that has a complementary does-a attribute of the form “does-a source-of-knife”. Here, there is a complementary does-a-needs-a match with the same source-of knife attribute.

The Technology Graph machinery can self-construct groups of hypotheses and full blown scenarios from basic hypotheses using their coupling attributes. Once constructed, the scenarios are made up of many hypotheses, each having its own Boolean expression specifying its dependence on supporting facts. Hence, the entire scenario is supported by these same facts, and a grand Boolean expression can be constructed according to the relationships among the component hypotheses.

One aspect of the present invention uses this grand Boolean expression to determine the optimal order of investigation of the unresolved facts in the inquiry. The first task in this process is an algebraic step for re-writing the Boolean expression in conjunctive normal form, i.e. as a set of clauses and'ed together, each clause of which contains variables (or not'ed variables) all or'ed together. For example, the present invention re-writes the following Boolean expression:

(a OR b OR c) AND (b OR NOT c OR e) AND (NOT c AND f AND NOT g) into the more compact representation:

(a|b|c)&(b|˜c|d)&(˜c & e & ˜f)

There are K=3 variables per clause, C=3 clauses and V=6 variables. Note also that there are overlapping variables. The K SAT problem, or in this case 3-SAT problem, is to ask if there is some value for these 6 Boolean variables such that the entire expression will evaluate to true. Clearly there are many values of the variables which will satisfy this expression. However, if we had many more clauses, the expression might be much harder to satisfy, especially if there were lots of overlapping variables. Hence for larger values of C and smaller values of V—or larger values of C/V—expressions of the type will in general be harder to satisfy. In fact, there is a dramatic shift—actually a phase transition—from generally easy to satisfy to generally impossible to satisfy at:

2^{K} ln 2, which for K=3 is 2³ ln 2˜=5.5

There is extensive literature on the satisfiability or SAT problem. See e.g. Computers and Intractability, A Guide to the Theory of NP-Completeness, Michael R. Garey and David S. Johnson, W. H. Freeman and Company, 1979, Section 3.1, the contents of which are herein incorporated by reference. The present invention, however, goes beyond the existing literature in that it considers the dynamic case of the optimal “moves” to make to resolve (and thus eliminate) variables in the K-SAT expression. A K-SAT expression may have lots of variables. One aspect of the present invention determines which variable to resolve such that the likelihood that the expression is satisfiable goes up maximally.

The present invention walks through though the K-SAT expression, considering each of the variables, one at a time. For each variable, it considers the effect of that variable resolving to true, and the effect of it resolving to false. For example, in the expression: (a|b|c) & (b|˜c|d) & (˜c & e & ˜f)

if variable d were to resolve to true, the entire second clause would be true, so it is eliminated altogether: (a|b|c) & (˜c & e & ˜f)

On the other hand, if d were to resolve to false, then the second clause is collapsed to a K=2 clause: (a|b|c) & (b|˜c) & (˜c & e & ˜f)

For every such clause—even for a non-homogeneous K—its satisfiability can be computed based on the profile of the expression, regardless of its particulars. This is important, because computing the satisfiability of specific expressions is an NP-hard problem. Hence, for large expressions computing satisfiability can be computationally infeasible. Accordingly, the present invention preferably computes satisfiability from a generic profile of the expression.

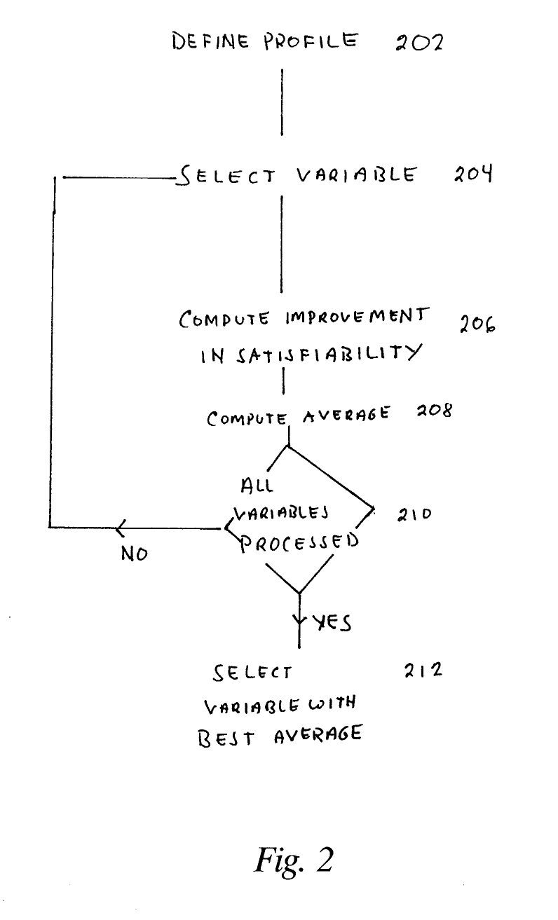

FIG. 2 shows a flow diagram of a method for determining which variable in an expression to resolve to improve the expression's satisfiability 200. As is known to persons of ordinary skill in the art, a flow diagram is a graph whose nodes are processes and whose arcs are dataflows. See Object Oriented Modeling and Design, Rumbaugh, J., Prentice Hall, Inc. (1991), Chapter 1. In step 202, the profile of the expression is defined. In the preferred embodiment, the profile is:

P(SAT)=1−Exp [−2\hat{ }v Exp [−c 2\hat{ }(−k)]]

In step 204, a variable is selected. In step 206, the method computes how much satisfiability can be expected to improve based on its candidate profiles. In step 208, the method computes an average of these satisfiability projections. In step 210, the method determines whether all variables have been processed. If not, control returns to step 204 to select another variable. If all variables have been processed, control proceeds to step 212. In step 212, the method selects the variable with the best average satisfiability projection. The best pick here becomes our recommendation for where to expend precious investigation resources on resolving the fact corresponding to the selected variable. Accordingly, the present invention also provides a principled method of making investigative decisions. IN other words, the method determines the best course of action for which facts to investigate and what might be the part of the story that would be most efficacious to attack.

The method for determining which variable in an expression to resolve to improve the expression's satisfiability has been applied to the solution of the “Five Houses” or Einstein” problem, a classic combinatorial distributed data problem. The Einstein problem provides the following clues: 1. The Brit lives in a red house; 2. The Swede keeps a dog; 3. The Dane drinks tea; 4. The green house is on the left of the white house; 5. The green house owner drinks coffee; 6. The person who smokes pall mall keeps birds; 7. The owner of the yellow house smokes dunhill; 8. The man living in the house right in the center drinks milk; 9. The Norwegian lives in the first house; 10. The man who smokes blend lives next to the one who keeps cats; 11. The man who keeps horses lives next to the man who smokes dunhill; 12. The owner who smokes blue master drinks beer; 13. The German smokes prince; 14. The Norwegian lives next to the blue house; and 15. The man who smokes blend has a neighbor who drinks water and asks the following question: Who keeps the fish. The solution takes a few seconds on a standard laptop computer. It involved the generation of over a hundred hypothesis agents and a thousand tuples. Accordingly, the present invention includes a paradigm for computation in the presence of noise and uncertainty. In that sense, it represents a departure from traditional computer science and is more like the “real world”.

The characteristics of the present invention offer many advantages. Phase transitions exist at the boundary of satisfiability and non-satisfiability of clauses made of variables. But the present invention goes beyond the satisfiability (SAT) context. In particular, it handles dynamical systems in which clauses enter and leave, generating cascades of implications and networks of inconsistency. One embodiment of the present invention handles these non-SAT dynamical systems by first driving to the boundary. The preferred embodiment of the present invention uses distributed reasoning. It generates new hypotheses from pieces of evidence. The evidence pieces have agency. It also avoids the “frame problem” with a co-learning loop with multiple human investigators. It truncates combinatorial explosions. The present invention learns from and augments expert human participants. It takes advantage of intrinsic nonlinearities in “convincement”. It makes suggestions when confronted with incomplete information and brings analytic rigor to noisy and inconsistent arguments. It makes use of the tension between redundancy and inconsistency.

To achieve real-world effectiveness, the present invention includes a large database of “common sense” (Cyc) for collecting inferences and associations that are culturally derived and for booting up an investigative engine with a modicum of smarts. It avoid the need to ask investigators questions like whether driving a car is associated with a person. The present invention further includes a computational infrastructure to attack large-scale problems (Saffron) including information brokering agents and distributed computing protocols.

The present invention includes additional aspects to further harness the power of TGs to generate the large Boolean expressions which formalize the meaning of the scenarios, which are used to do a K-SAT analysis to optimally direct efficacious investigations as explained above. Technology graphs (TGs) are not only a mechanism for self-constructing large edifices out of component parts. In addition, TGs, once constructed, are the blue prints for the very factory we can use to produce the goods and services described by the Graph. For example, an automobile engine can self-construct from pistons, valves, etc. When the graph for this specific automobile is complete, it is, in effect, the factory for building lots of engines. An aspect of the present invention uses the power of TGs to, in effect, manufacture the scenarios' Boolean expressions.

To accomplish this, the present invention generalizes the “facts” to Java-style or Technology Graph evidence objects. Hence, the hypotheses not only couple with other hypotheses, they also build links to these new evidence objects, which provide the necessary factual support for the hypotheses. In TG terms, these evidence objects provide the raw materials for the ultimate products, the scenarios.

Lower level hypotheses are the analog of sub-assemblies in manufacturing. They build their sub-components mostly from raw materials (evidence objects), and perhaps some other low-level sub-assemblies as well. The currency or “stuff” of these sub-assemblies are Boolean expressions, which at the lower levels are small fragments of what will become the large Boolean expressions of the complete scenarios.

The choice of Boolean operators in the expressions correspond to the notion of complements and substitutes in Technology Graphs. An example of a complement is a hammer and a nail. An example of a substitute is a nail and a screw. In complements, both are required, so complements correspond to AND operations in Boolean algebra. In substitutes, one or the other is required, so supplements corresponding to OR operations in Boolean algebra.

When the present invention's evidence marshalling TG “manufactures”, it manufactures Boolean expressions according to the discipline of complements and substitutes. In criminal inquiries, a receipt OR a witness may be needed. Further a wapon AND a mode of transportation may be needed. Hence, scenarios and fragments of scenarios correspond to Boolean expressions, with their AND and OR clauses logically organizing factual or evidence information.

The present invention “executes” its TG factory to produce scenarios. Typically, there will be lots of ways to produce our final products, so lots of (slightly) different products are produced. Using chairs as an example, chairs with padded seats or chairs with bare-wood seats may be manufactured. Analogously, when producing scenarios, some will have Joe wielding a knife and others will have Pete wielding a knife.

In one embodiment, the present invention performs a K-SAT analysis on each scenario (Boolean expression) rolling off the end of the TG factory and scores it for its likelihood of satisfiability. It then picks a number of promising scenario candidates, as all possible. Next, the disjunction (OR) of the expressions for the scenario candidates is determined. The ensuing larger Boolean expression is rewritten into conjunctive normal form, which can be passed to the dynamic K-SAT machinery of the method of FIG. 2

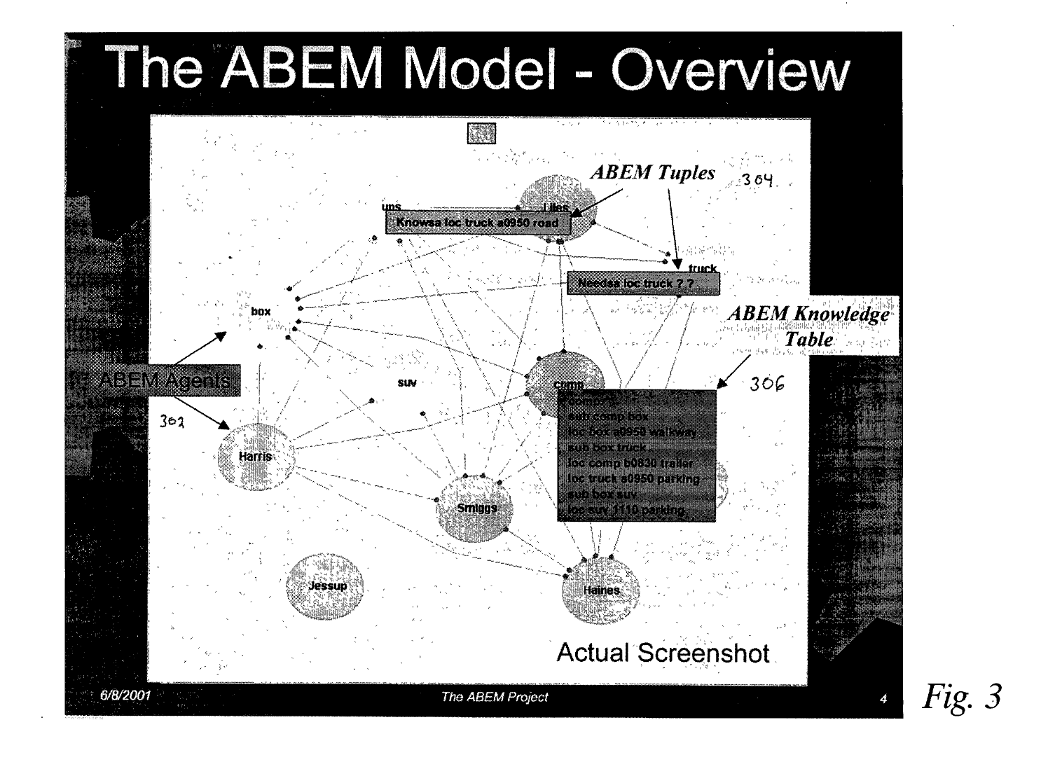

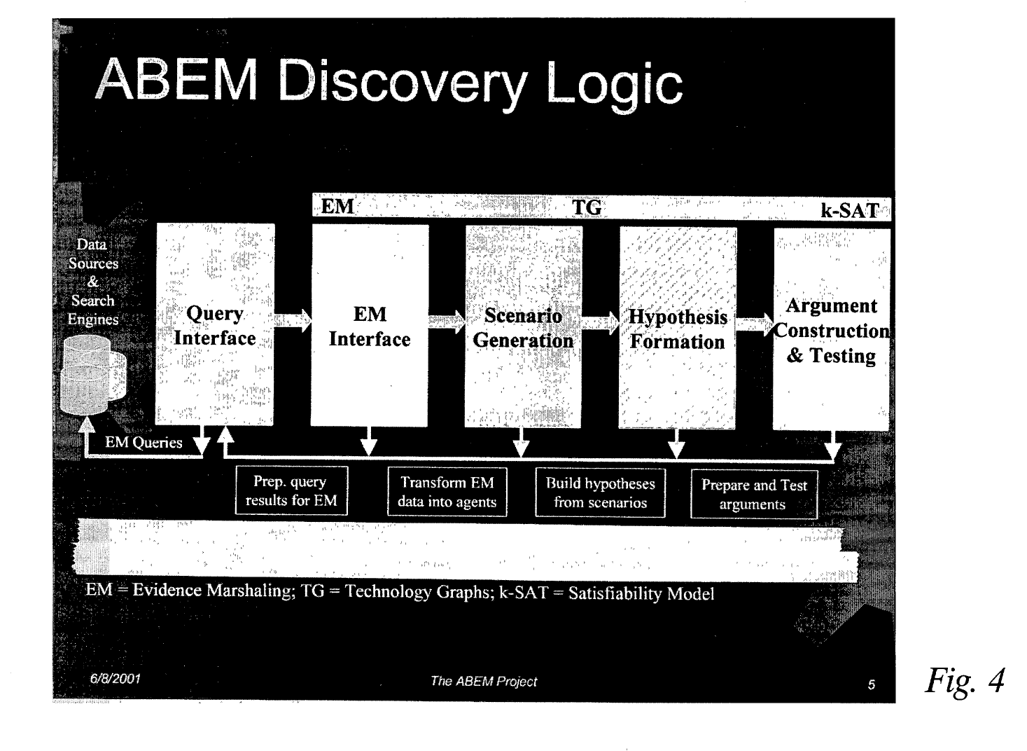

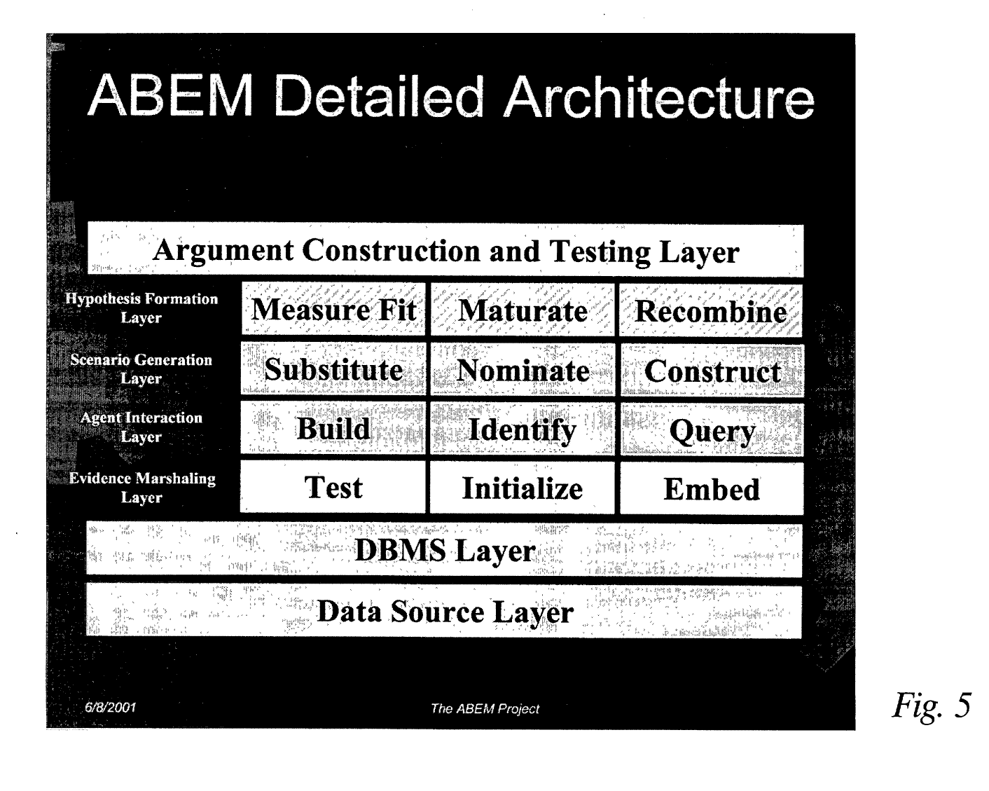

FIG. 3 displays an overview of the Agent Based Evidence Marshalling Model (ABEM) 300 of the present invention. It shows many components of the ABEM including the agents 302 representing objects, the tuples 304 for encoding linkages in the technology graph and the knowledge table 306 of one of the agents. FIG. 4 displays the components, functions and data representations of the present invention. FIG. 5 displays a detailed architecture of ABEM.

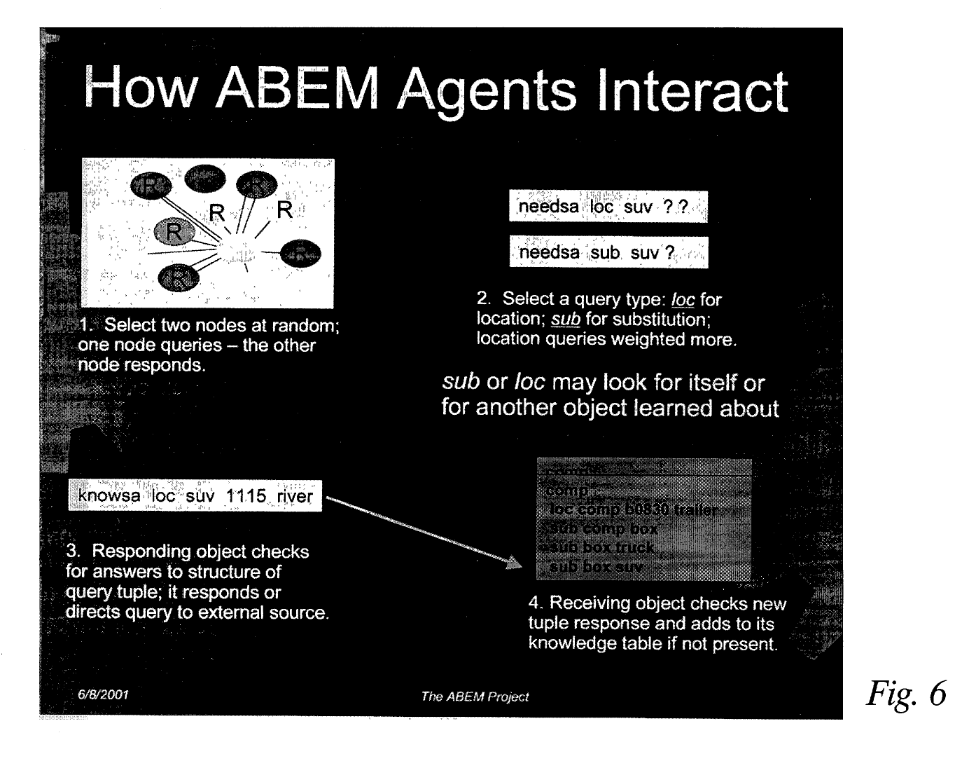

FIG. 6 shows how the agents in the ABEM interact. In the first step, one node queries and the other node responds. In the second step, a query type is selected. Loc represents location and sub represents substitution. In the preferred embodiment, the location queries are given more weight. In the third step, a responding object checks for answers to structure of the query tuple. It either responds or directs the query to an external source. In the fourth step, the receiving object checks the new tuple response and adds it to its knowledge table if the tuple response is not already there.

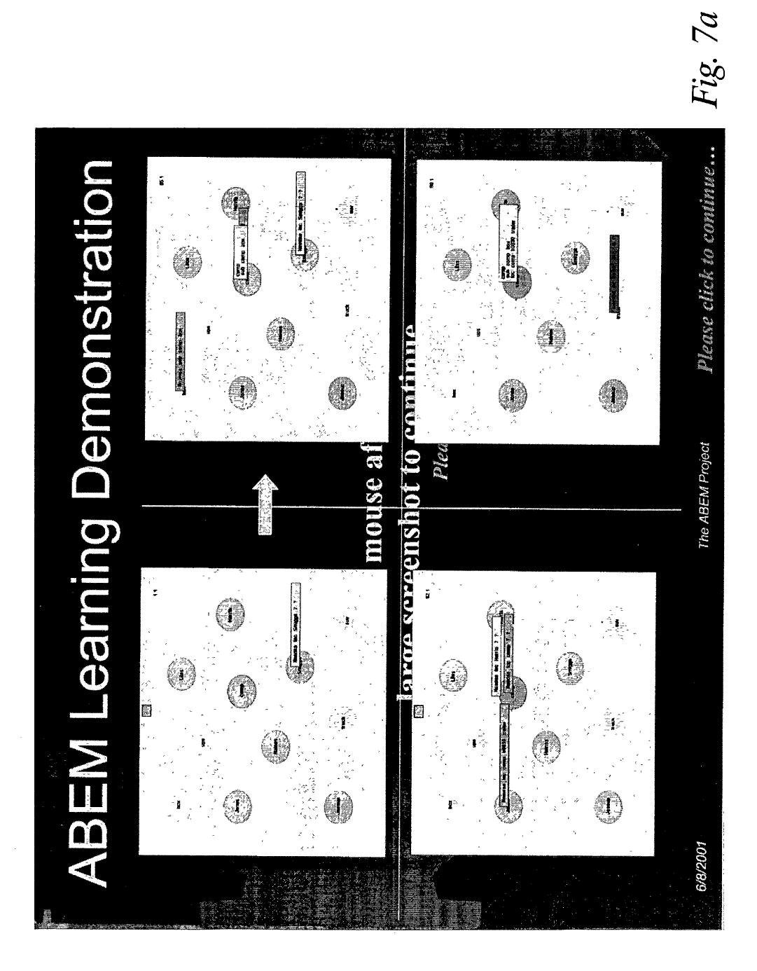

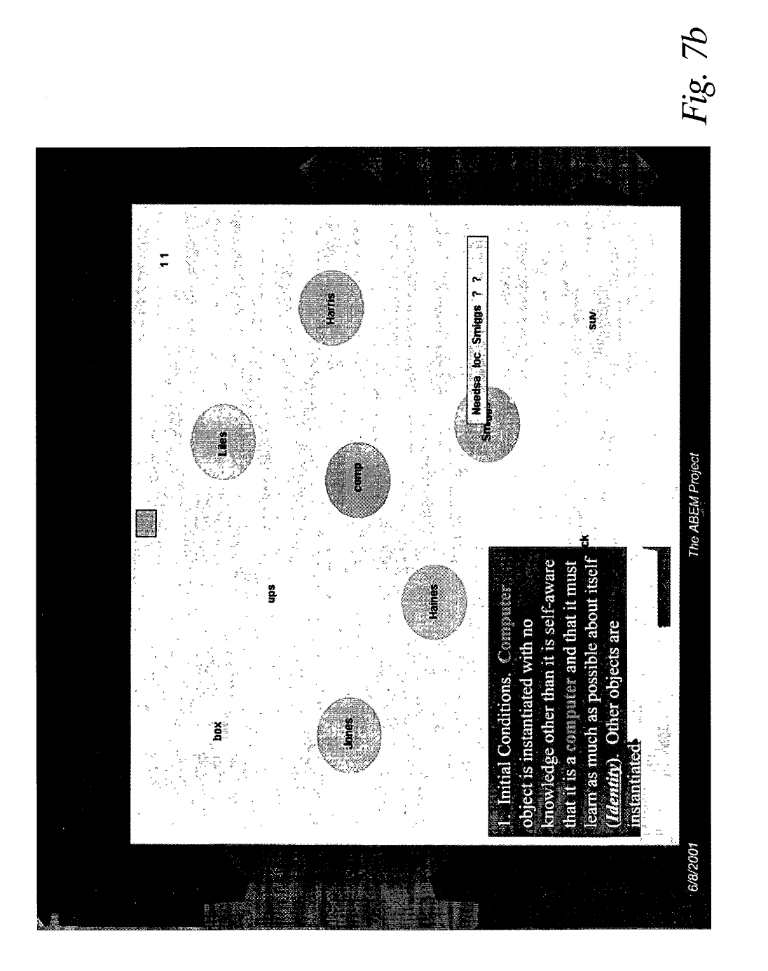

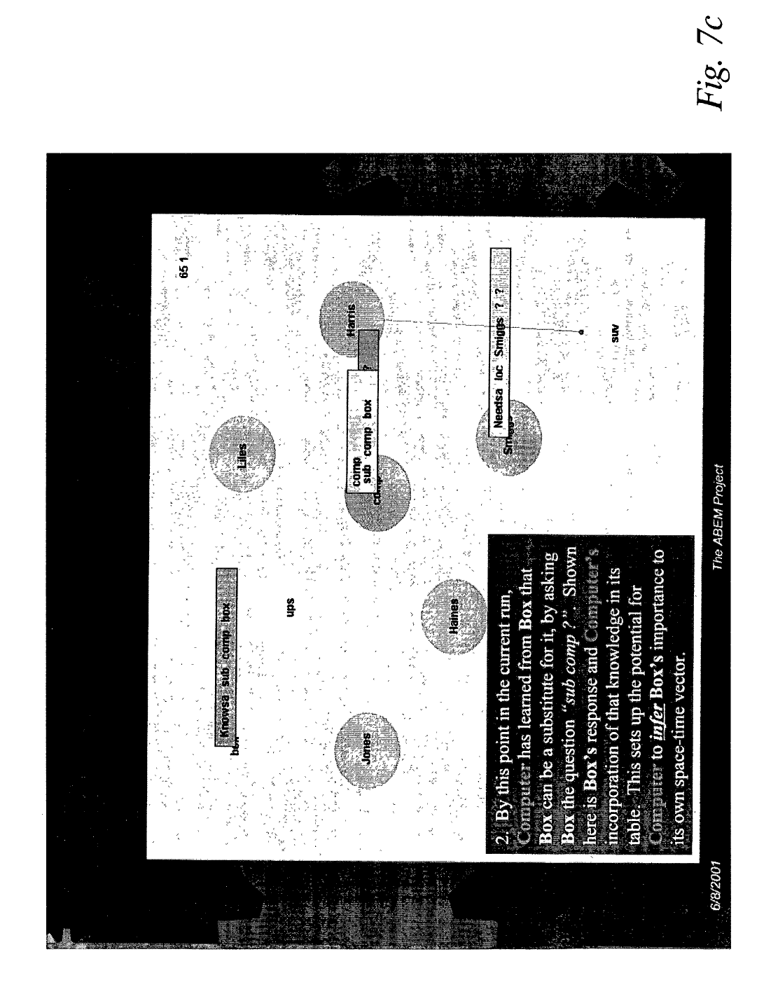

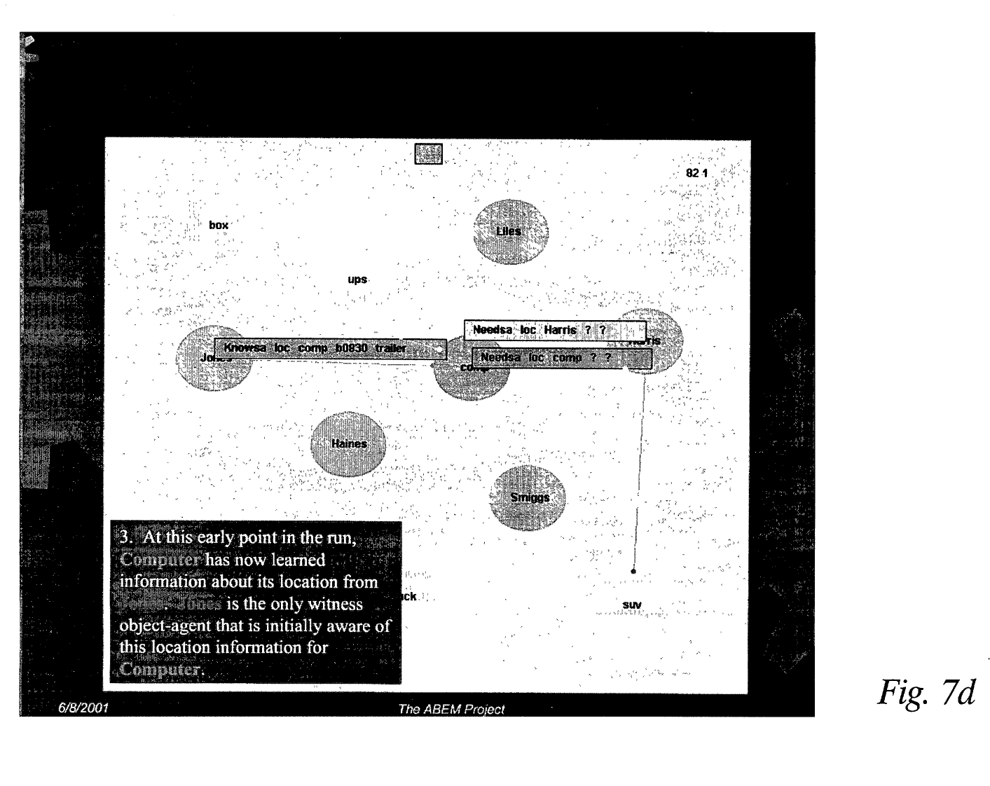

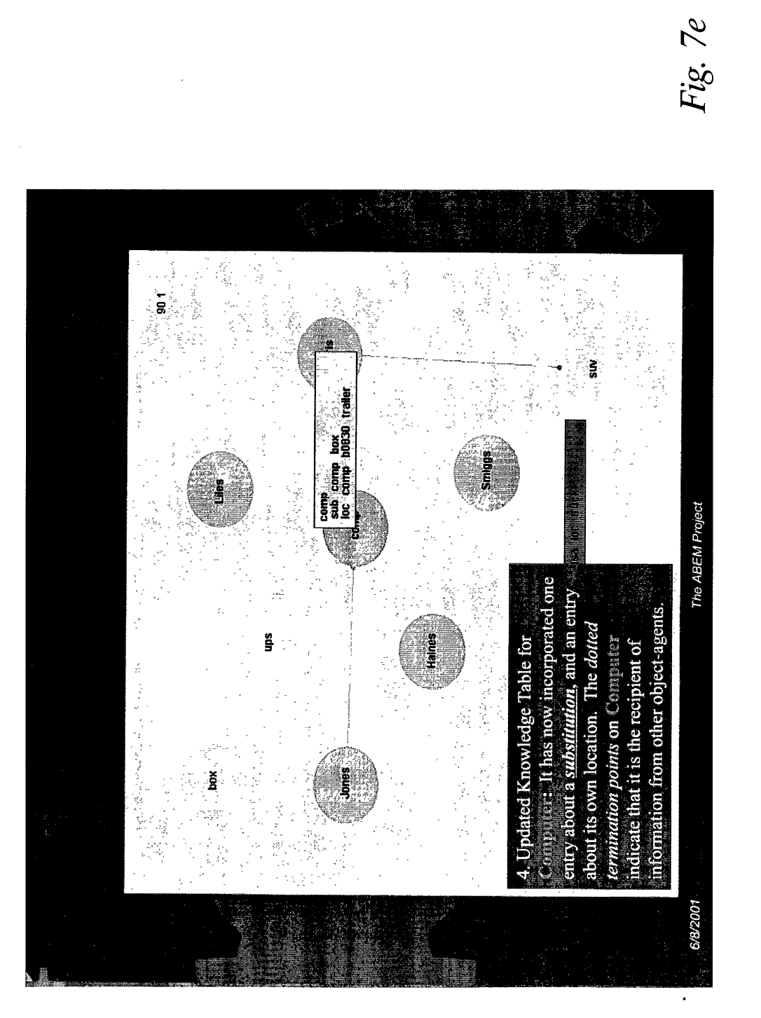

FIGS. 7A-7E, 8A-8E and 9A-9E show panels from an execution of the ABEM. FIG. 7A shows the panels from FIGS. 7B-7E on one sheet. FIG. 7B illustrates initial conditions. The computer object is instantiated with no knowledge other than its self-awareness that it is a computer and that it must learn as much as possible about itself (Identity). Other objects are also instantiated. FIG. 7C illustrates the state of ABEM after the Computer has learned from the Box that the Box can be its substitute. The Computer learns this by asking the Box the question: “Sub comp?”. FIG. 7C also shows the Box's response and the Computer's incorporation of that knowledge in its table. This sets up the potential for the Computer to infer the Box's importance to its own space-time vector. FIG. 7D illustrates the state of ABEM after the Computer has learned information about is location from Jones. Jones is the only witness object-agent that is initially aware of this location information for the Computer. FIG. 7E illustrates the updated knowledge table for the Computer. It has now incorporated one entry about a substitution, and an entry about its own location. The dotted termination points on Computer indicate that it is the recipient of information from other object-agents.

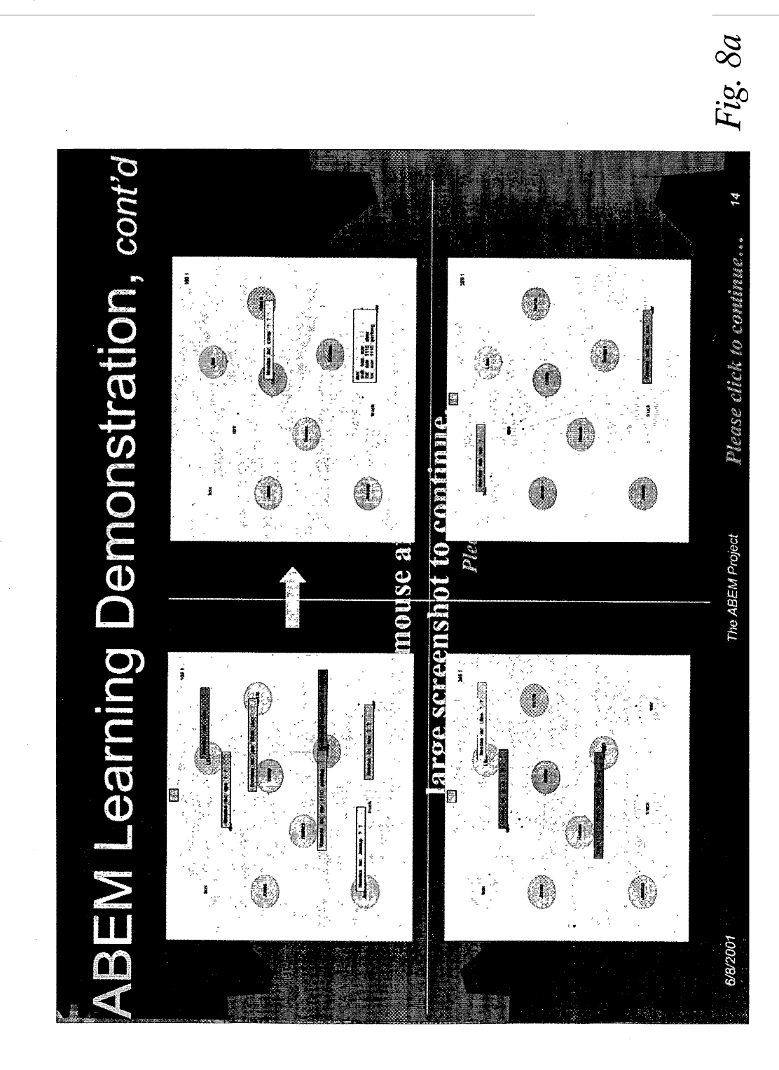

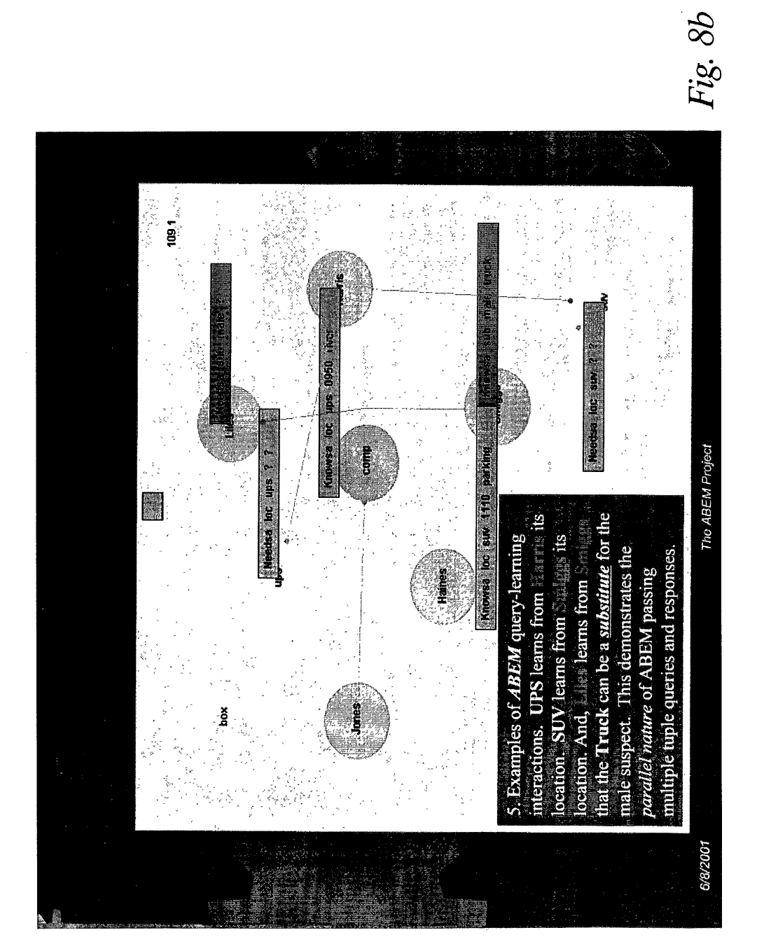

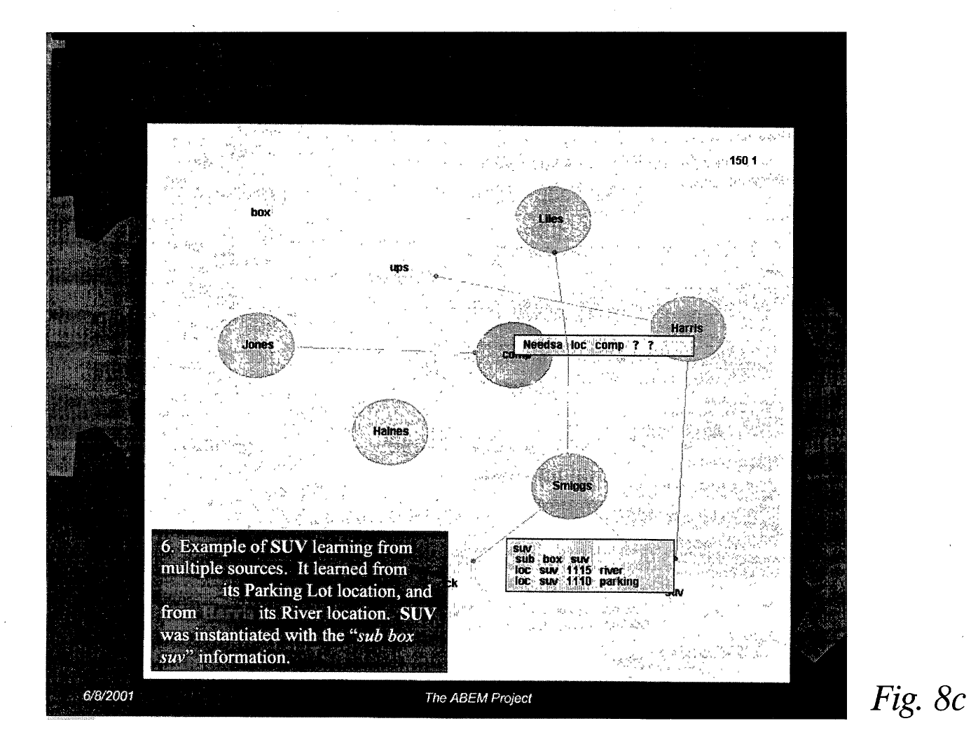

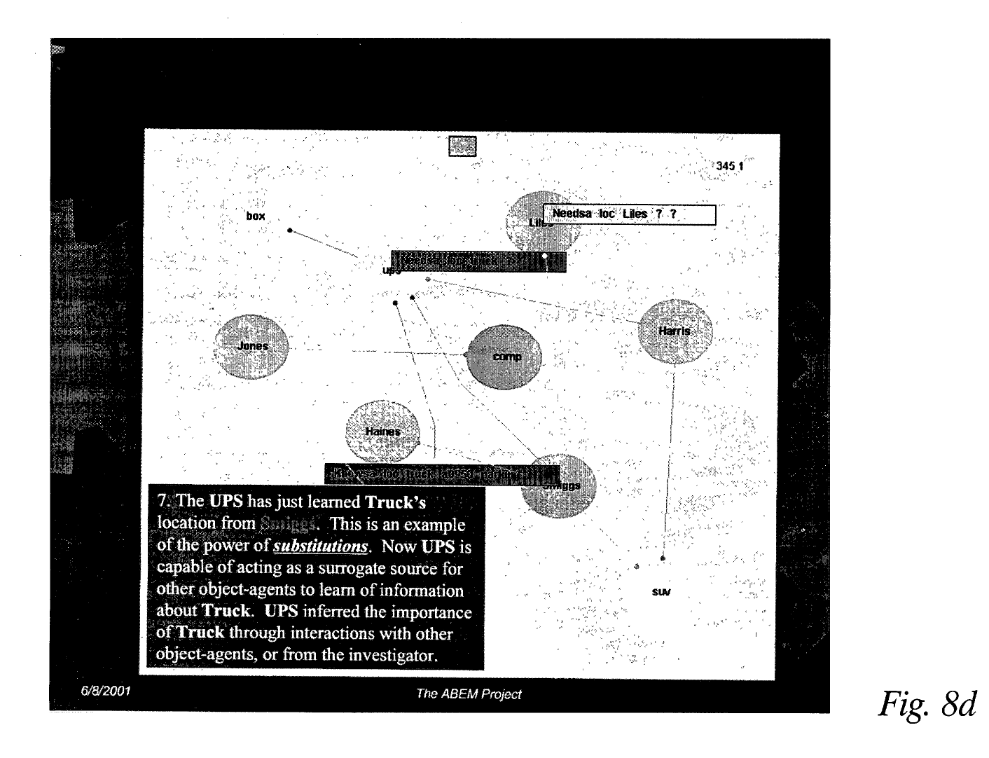

FIG. 8A shows the panels from FIGS. 8B-8E on one sheet. FIG. 8B displays examples of query-learning interactions in ABEM. UPS learns its location from Harris. SUV learns its location from Smiggs. Liles learns that the Truck can be a substitute for the male suspect from Smiggs. This demonstrates the parallel nature with which ABEM passes multiple tuple queries and responses. FIG. 8C shows examples of the SUV learning from multiple sources. The SUV learned its Parking Lot location and its River location from Smiggs and Harris respectively. SUV was instantiated with the “sub box suv” information. FIG. 8D shows the state of ABEM after the UPS has learned the Truck's location from Smiggs. This is an example of the power of substitutions. Now UPS is capable of acting as a surrogate source for other object-agents to learn of information about Truck. UPS inferred the importance of Truck through interactions with other object-agents, or from the investigator. FIG. 8E illustrates the state of ABEM as the Box learns of a critical substitutionary relationship: “sub box suv” from the SUV. This important item of information is typically propagated to other object-agents, including the Computer, to help build more detailed space-time vectors for several object-agents.

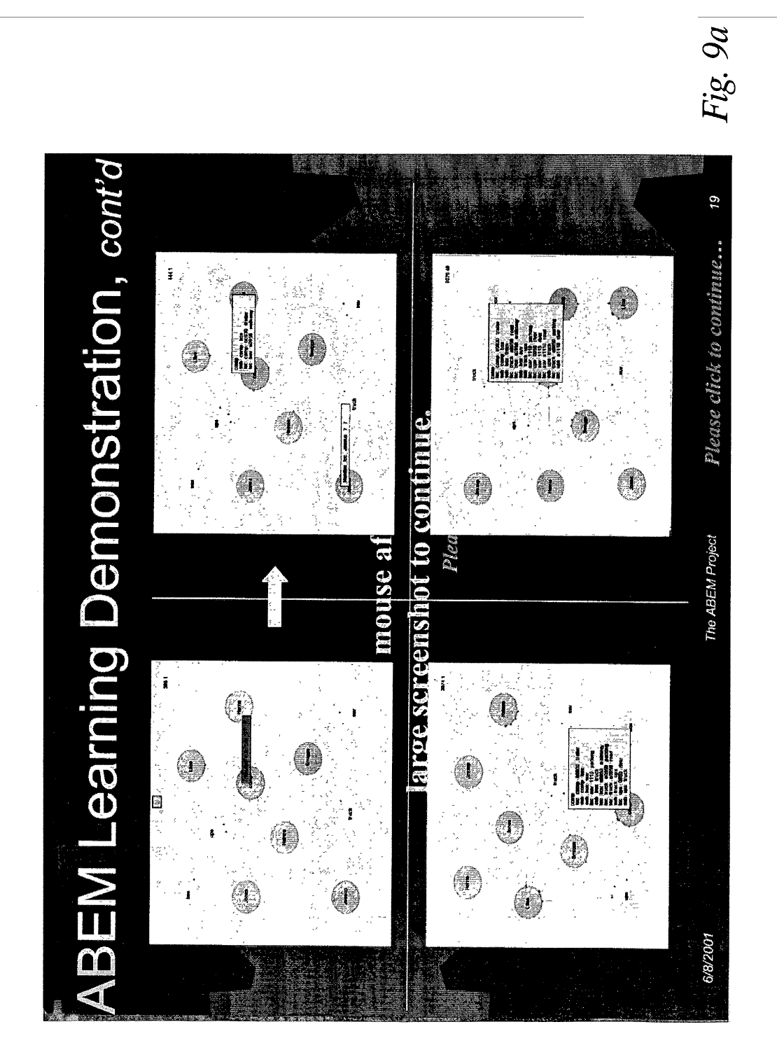

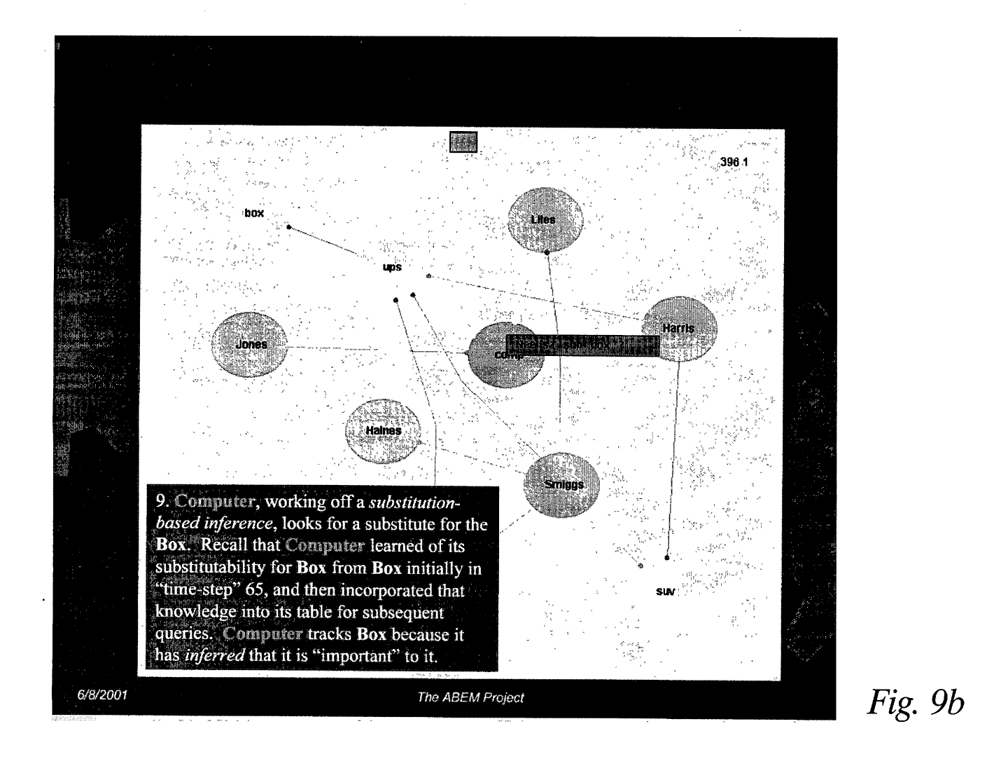

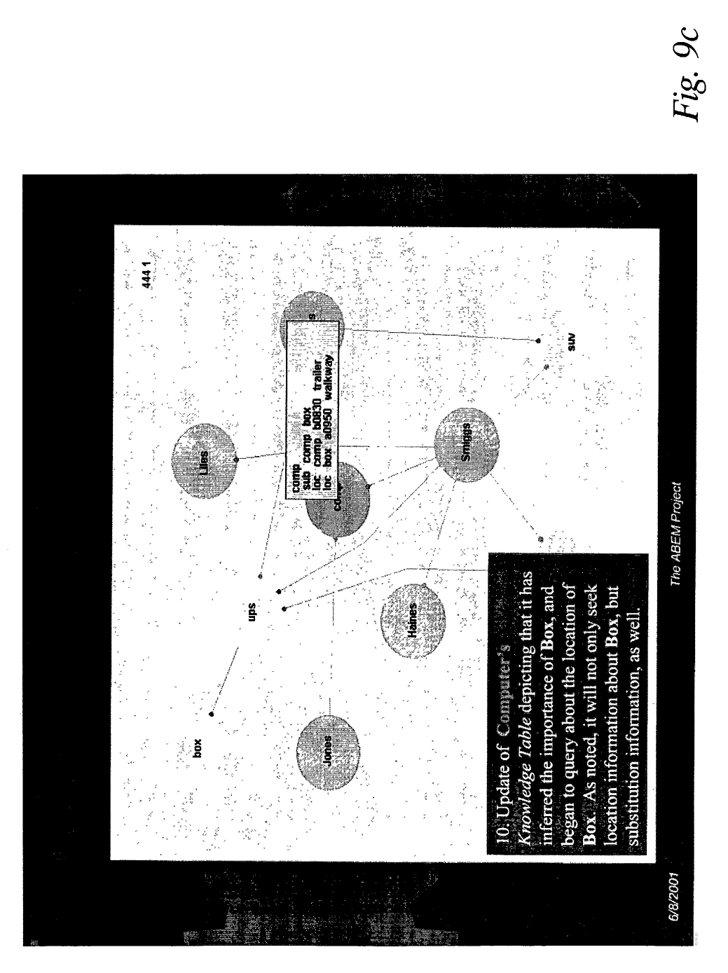

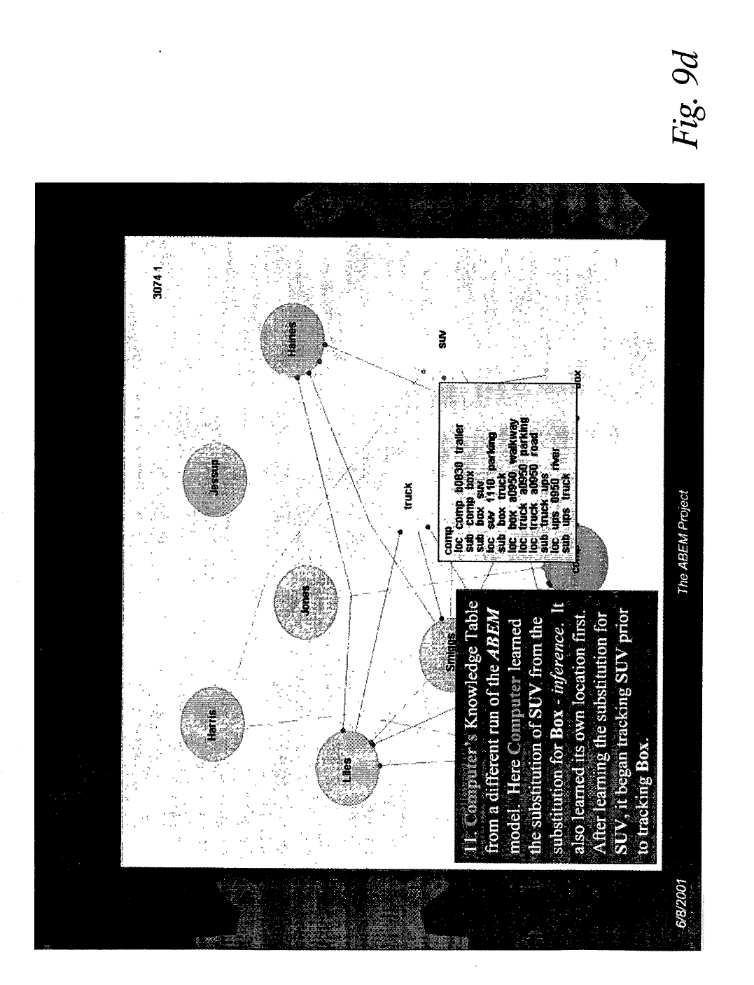

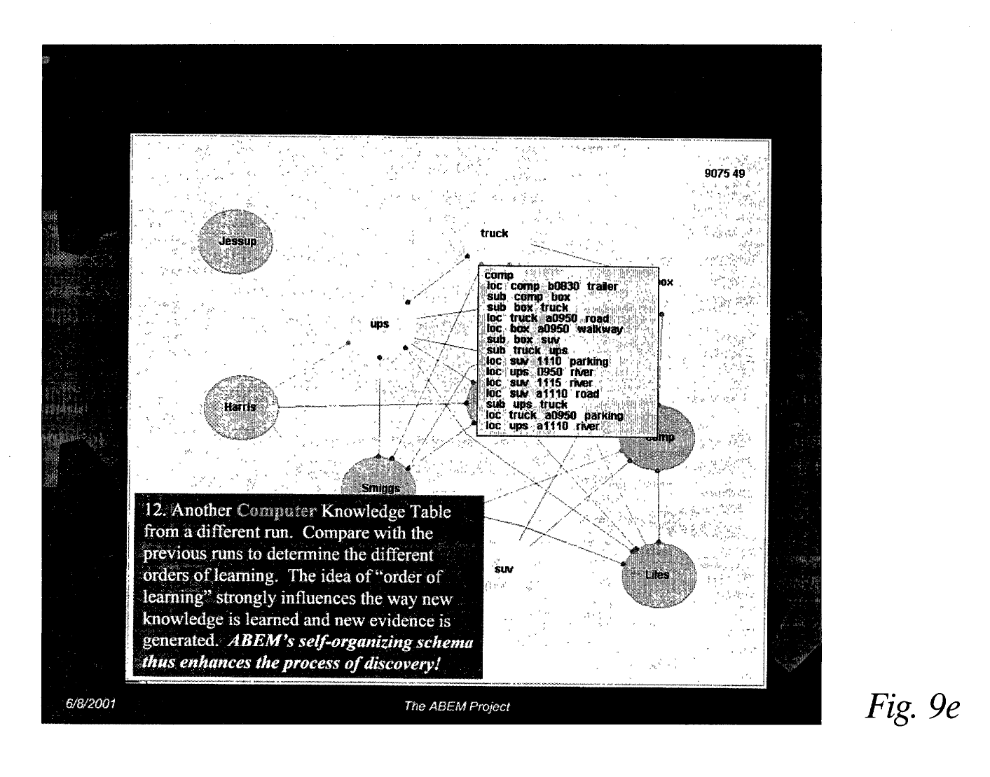

FIG. 9A shows the panels from FIGS. 9B-9E on one sheet. FIG. 9B shows the Computer, working of a substitution-based inference, looking for a substitute for the Box. Recall that the Computer has learned of its substitutability for the Box from the Box in a previous time step, and then incorporated that knowledge into its table for subsequent queries. The Computer tracks the box because it has inferred that it is important to it. FIG. 9C shows the update of the Computer's knowledge table depicting that it has inferred the importance of the Box. The knowledge table also depicts that the Computer has begun to query about the location of the Box. The Computer will not only seek location information about Box, but will seek substitution information as well. FIG. 9D illustrates the Computer's knowledge table from a different run of the ABEM model. Here, the Computer learned the substitution of SUV from the substitution for the Box—inference. It also learned its own location first. After learning the substitution for SUV, it began tracking SUV prior to tracking the BOX. FIG. 9E shows an additional Computer Knowledge Table from an additional run. Comparing this run with the runs from previous runs shows that the idea of “order of learning” strongly influences the way new knowledge is learned and new evidence is generated. Accordingly, ABEM's self-organizing schema enhances the process of discovery.

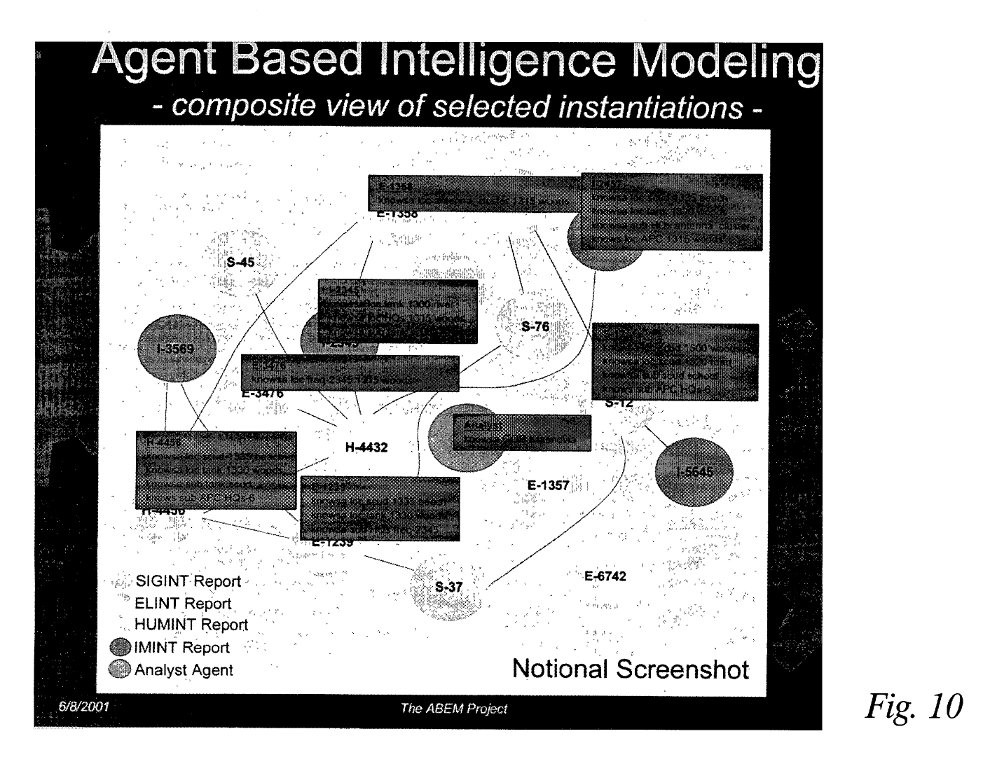

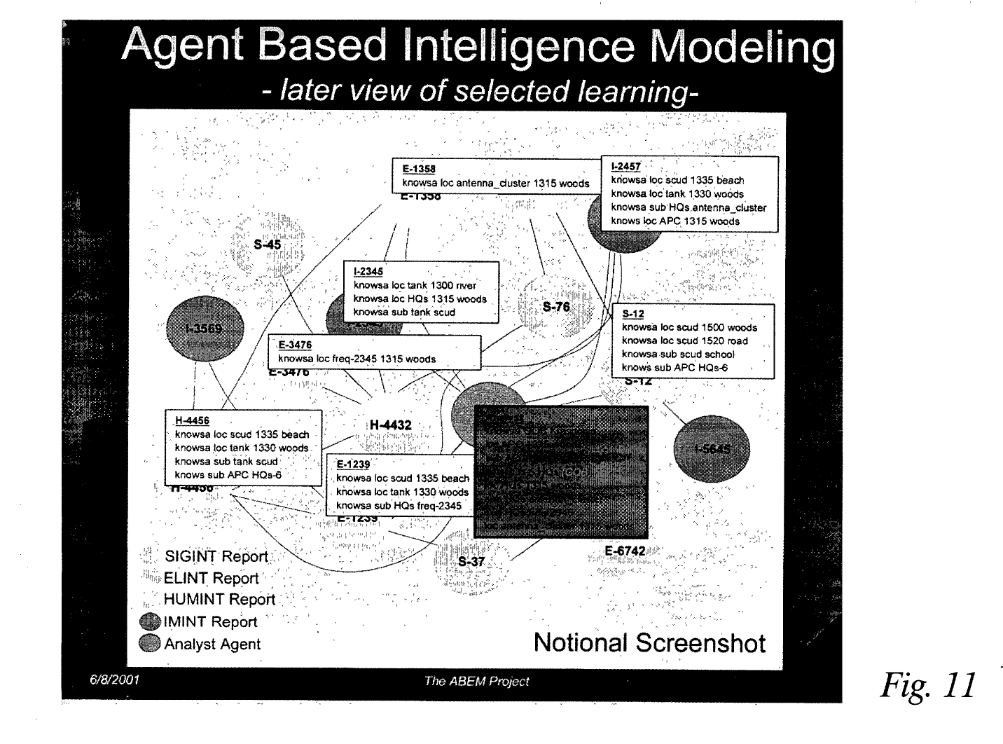

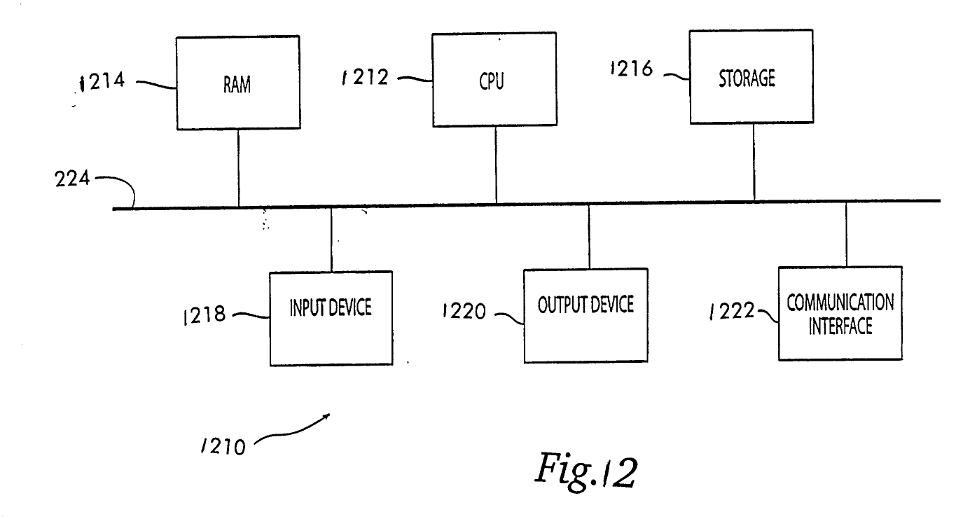

FIG. 10 shows a composite view of selected instantiations in ABEM. FIG. 11 shows a later view of selected learning in ABEM.

FIG. 12 discloses a representative computer system 1210 in conjunction with which the embodiments of the present invention may be implemented. Computer system 210 may be a personal computer, workstation, or a larger system such as a minicomputer. However, one skilled in the art of computer systems will understand that the present invention is not limited to a particular class or model of computer.

As shown in FIG. 12, representative computer system 1210 includes a central processing unit (CPU) 1212, a memory unit 1214, one or more storage devices 1216, an input device 1218, an output device 1220, and communication interface 1222. A system bus 1224 is provided for communications between these elements. Computer system 1210 may additionally function through use of an operating system such as Windows, DOS, or UNIX. However, one skilled in the art of computer systems will understand that the present invention is not limited to a particular configuration or operating system.

Storage devices 1216 may illustratively include one or more floppy or hard disk drives, CD-ROMs, DVDs, or tapes. Input device 1218 comprises a keyboard, mouse, microphone, or other similar device. Output device 1210 is a computer monitor or any other known computer output device. Communication interface 1222 may be a modem, a network interface, or other connection to external electronic devices, such as a serial or parallel port

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

1. A system for performing an investigation to determine one or more hypotheses comprising:
one or more nodes representing one or more objects wherein said one or more nodes comprise one or more tuples representing questions and answers and wherein said nodes exchange said one or more tuples to perform the investigation.

2. A system for performing an investigation to determine one or more hypotheses as in claim 1 further comprising:
one or more edges connecting at least two of said nodes to form at least one graph for representing relations among the objects.

3. A system for performing an investigation to determine one or more hypotheses as in claim 2 further comprising:
one or more utilities to detect a phase transition in the graph representing a movement from a brittle scenario of the hypotheses supported by few precarious paths in the graph to a robust scenario of the hypotheses supported by multiple paths in the graph.

4. A system for performing an investigation to determine one or more hypotheses as in claim 1 wherein the relations comprise one or more members of the set consisting of needsa, hasa, doesa, and isa.

5. A system for performing an investigation to determine one or more hypotheses as in claim 1 wherein incompleted ones of said tuples represent questions.

6. A system for performing an investigation to determine one or more hypotheses as in claim 1 wherein completed ones of said tuples represent answers.

7. A system for performing an investigation to determine one or more hypotheses as in claim 1 wherein said tuples comprise one or more members of the set consisting of substitution tuples and location tuples.

8. A system for performing an investigation to determine one or more hypotheses as in claim 7 wherein said substitution tuples determine whether one of the objects can fit in another of the objects.

9. A system for performing an investigation to determine one or more hypotheses as in claim 1 wherein said one or more nodes also exchange said one or more tuples with at least one human expert.

10. A system for performing an investigation to determine one or more hypotheses as in claim 9 wherein at least one of the nodes represents the human expert.

11. Computer executable software code stored on a computer readable medium, the code for performing an investigation to determine one or more hypotheses, the code comprising:
code to represent one or more objects with one or more nodes;
code to store questions and answers in one or more tuples at said one or more nodes; and
code to exchange said tuples among the one or more nodes to perform the investigation.

12. Computer executable software code stored on a computer readable medium, the code for performing an investigation to determine one or more hypotheses as in claim 11, wherein said code to perform an investigation to determine one or more hypotheses further comprises:
code to connect at least two of the nodes with one or more edges to form at least one graph wherein the edges represent relations among the objects.

13. Computer executable software code stored on a computer readable medium, the code for performing an investigation to determine one or more hypotheses as in claim 12, wherein said code to perform an investigation to determine one or more hypotheses further comprises:
code to detect a phase transition in the graph representing a movement from a brittle scenario of the hypotheses supported by few precarious paths in the graph to a robust scenario of the hypotheses supported by multiple paths in the graph.

14. Computer executable software code stored on a computer readable medium, the code for performing an investigation to determine one or more hypotheses as in claim 11, wherein incompleted ones of said tuples represent questions and completed ones of said tuples represent answers.

15. Computer executable software code stored on a computer readable medium, the code for performing an investigation to determine one or more hypotheses as in claim 11, wherein said code to perform an investigation to determine one or more hypotheses further comprises:
code to exchange said one or more tuples with at least one human expert.

16. A programmed computer system for performing an investigation to determine one or more hypotheses comprising at least one memory having at least one region storing computer executable program code and at least one processor for executing the program code stored in said memory, wherein the program code includes
code to represent one or more objects with one or more nodes;
code to store questions and answers in one or more tuples at said one or more nodes; and
code to exchange said tuples among the one or more nodes to perform the investigation.

17. A programmed computer system for performing an investigation to determine one or more hypotheses comprising at least one memory having at least one region storing computer executable program code and at least one processor for executing the program code stored in said memory as in claim 16, wherein said code further includes:
code to connect at least two of the nodes with one or more edges to form at least one graph wherein the edges represent relations among the objects.

18. A programmed computer system for performing an investigation to determine one or more hypotheses comprising at least one memory having at least one region storing computer executable program code and at least one processor for executing the program code stored in said memory as in claim 17, wherein said code further includes:
code to detect a phase transition in the graph representing a movement from a brittle scenario of the hypotheses supported by few precarious paths in the graph to a robust scenario of the hypotheses supported by multiple paths in the graph.

19. A programmed computer system for performing an investigation to determine one or more hypotheses comprising at least one memory having at least one region storing computer executable program code and at least one processor for executing the program code stored in said memory as in claim 16, wherein incompleted ones of said tuples represent questions and completed ones of said tuples represent answers.

20. A programmed computer system for performing an investigation to determine one or more hypotheses comprising at least one memory having at least one region storing computer executable program code and at least one processor for executing the program code stored in said memory as in claim 16, wherein said code further includes:
code to exchange said one or more tuples with at least one human expert.
